(19) United States
(12) Patent Application Publication
(10) Pub. No.: US 2026/0064216 A1
(43) Pub. Date: Mar. 5, 2026

(54) ELECTRONIC PEN AND PEN PRESSURE OUTPUT METHOD

(71) Applicant: Wacom Co., Ltd., Saitama (JP)

(72) Inventor: Takeshi KOIKE, Saitama (JP)

(73) Assignee: Wacom Co., Ltd., Saitama (JP)

(21) Appl. No.: 19/305,287

(22) Filed: Aug. 20, 2025

(30) Foreign Application Priority Data
Aug. 27, 2024 (JP) 2024-145960

(51) Int. Cl. G06F 3/041; G06F 3/0354

(52) U.S. Cl. CPC G06F 3/04162; G06F 3/03545; G06F 2203/04105

(57) ABSTRACT

An electronic pen indicates a position on a planar sensor through communication with an electronic apparatus having the planar sensor. The electronic pen includes a pen pressure sensor that outputs a detected signal correlated with a pen pressure amount acting on a pen tip and a control circuit that is connected to the pen pressure sensor. The control circuit adjusts, on a conversion characteristic curve to which a detected value indicated by the detected signal output from the pen pressure sensor is input and from which a converted value indicating a magnitude of the pen pressure amount is output, a rise sensitivity, in which the pen pressure amount shifts from zero to non-zero, in response to detection of a predetermined event.

### BACKGROUND

### Technical Field

The present disclosure relates to an electronic pen and a pen pressure output method.

### Description of the Related Art

An input system is known, which includes an electronic pen (a stylus) as a position indicator and an electronic apparatus including a touch sensor. In this type of systems, a pen pressure sensor provided at a pen tip of the electronic pen detects a pen pressure amount acting on the pen tip, and the pen pressure amount is used to control ink rendering which simulates the sense of analog writing.

Due to malfunction, friction, wear of a pen pressure sensor, or the like for example, even when the electronic pen is in a hover state, a positive pen pressure amount may be detected by the pen pressure sensor. To solve the problem, various methods have been proposed to prevent unintended ink rendering in a case where a pen pressure amount is detected inconsistently with the hover state.

U.S. Pat. No. 11,163,396 discloses an electronic pen that receives a transmission signal from a touch device through a first antenna and a second antenna, determines a distance to the touch device based the received signal, and transmits to the touch device a command signal for executing ink rendering according to the distance.

However, in the method disclosed in U.S. Pat. No. 11,163,396, since the electronic pen itself determines the distance and determines whether or not to execute ink rendering, it may be necessary to implement different determination processing depending on the software specifications or hardware specifications of the electronic apparatus.

### BRIEF SUMMARY

According to one aspect, the present disclosure is directed to providing an electronic pen and a pen pressure output method capable of suppressing unwanted ink rendering in a manner that is not affected by the specifications of an electronic apparatus for performing ink rendering.

According to a first aspect, an electronic pen indicates a position on a planar sensor through communication with an electronic apparatus having the planar sensor, and the electronic pen includes a pen pressure sensor that outputs a detected signal correlated with a pen pressure amount acting on a pen tip and a control circuit. The control circuit is connected to the pen pressure sensor and adjusts, on a conversion characteristic curve to which a detected value indicated by the detected signal output from the pen pressure sensor is input and from which a converted value indicating a magnitude of the pen pressure amount is output, based on detection of a predefined event, a rise sensitivity in which the pen pressure amount shifts from zero to non-zero.

According to a second aspect, a pen pressure output method is provided for an electronic pen that indicates a position on a planar sensor through communication with an electronic apparatus having the planar sensor. The electronic pen acquires a detected signal correlated with a pen pressure amount acting on a pen tip, and adjusts, on a conversion characteristic curve to which a detected value indicated by the acquired detected signal is input and from which a converted value indicating a magnitude of the pen pressure amount is output, based on detection of a predefined event, a rise sensitivity in which the pen pressure amount shifts from zero to non-zero.

According to a third aspect, an electronic pen indicates a position on a planar sensor through communication with an electronic apparatus having the planar sensor, and the electronic pen includes a pen pressure sensor that sequentially outputs a detected signal correlated with a pen pressure amount acting on a pen tip and a control circuit connected to the pen pressure sensor. The control circuit includes a signal processing section that applies signal processing to a time series of signal values indicated by the detected signals and acquires a detected value that is the signal value with a signal waveform or a frequency characteristic changed in the time series of the signal values. The control circuit includes a processing update section that sequentially updates signal processing information, which relates to presence or absence of said signal processing or an arithmetic operation of said signal processing, according to a magnitude or an amount of time change of the signal values.

According to a fourth aspect, a pen pressure output method is provided for an electronic pen that indicates a position on a planar sensor through communication with an electronic apparatus having the planar sensor. The electronic pen sequentially acquires a detected signal correlated with a pen pressure amount acting on a pen tip, and applies first signal processing to a time series of signal values indicated by the detected signals to acquire a detected value that is the signal value with a signal waveform or a frequency characteristic changed in the time series of the signal values. The electronic pen sequentially updates signal processing information, which relates to presence or absence of or an arithmetic operation of said signal processing, according to a magnitude or an amount of time change of the signal values.

According to the present disclosure, it is possible to suppress unwanted ink rendering in a manner that is not affected (limited) by the specifications of an electronic apparatus for performing ink rendering.

### BRIEF DESCRIPTION OF THE SEVERAL VIEWS OF THE DRAWINGS

FIG. 1 is an overall configuration diagram of an input system into which an electronic pen is incorporated;

FIG. 2 is a diagram schematically depicting an internal structure of the electronic pen of FIG. 1;

FIG. 3 is an electrical block diagram of the electronic pen depicted in FIG. 1 and FIG. 2;

FIG. 4 is a functional block diagram related to a first operation of a control circuit depicted in FIG. 3;

FIG. 5 is a diagram depicting an example of a correspondence relation between a detected value, a converted value, and a pen pressure amount;

FIG. 6 is a diagram depicting a conversion characteristic curve corresponding to the correspondence relation of FIG. 5;

FIG. 7 is a flowchart depicting an example of an update operation to update the conversion characteristic curve performed by the control circuit of FIG. 3 and FIG. 4;

FIG. 8 is a diagram depicting an example of a method of setting the number of samples when reception is possible;

FIG. 9 is a diagram depicting an example of a method of determining (defining) the conversion characteristic curve;

FIG. 10 is a diagram depicting an example of a method of adjusting a pen pressure sensitivity;

FIG. 11 is a functional block diagram related to a second operation of the control circuit depicted in FIG. 3;

FIG. 12 is a flowchart depicting an example of a smoothing operation of a signal value performed by the control circuit of FIG. 3 and FIG. 11;

FIG. 13 is a diagram depicting an example of a method of determining an activation multiplier; and

FIG. 14 is a diagram depicting effects of adaptive filter processing.

### DETAILED DESCRIPTION

An embodiment of the present disclosure will be described with reference to the accompanying drawings. In order to facilitate the understanding of the description, the same constitutional elements in each drawing will be denoted by the same reference signs as much as possible, and duplicate description will be omitted. In addition, the term “section” may be replaced with another term such as “unit,” “module,” “device,” or “element,” for example.

### Configuration of Electronic Pen 12

### Overall Configuration of Input System 10

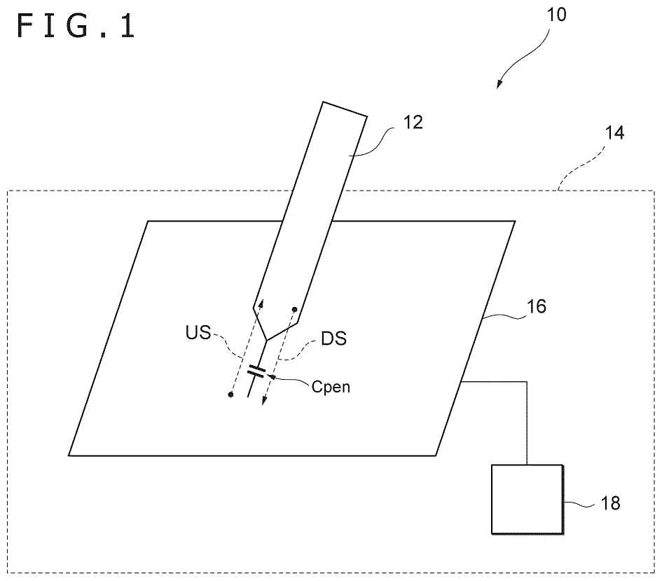

FIG. 1 is an overall configuration diagram of an input system 10 into which an electronic pen 12 in an embodiment of the present disclosure is incorporated. The input system 10 is configured to be capable of providing a “digital ink service” that handles handwritten content input by a user as digital data. Specifically, the input system 10 includes the electronic pen 12 and an electronic apparatus 14 used together with the electronic pen 12.

The electronic pen 12 is a pen-type pointing device and is configured to be capable of communicating with the electronic apparatus 14 in one direction or both directions. In the embodiment, the electronic pen 12 is an active capacitance coupling (AES) stylus. The electronic pen 12 and the electronic apparatus 14 are capacitively coupled to each other by capacitance Cpen.

The electronic apparatus 14 is a computer owned by the user, and may be, for example, a tablet, a smartphone, a personal computer, or the like. Specifically, the electronic apparatus 14 may include, in addition to a planar sensor 16 and a sensor controller 18, a host processor, a memory, a communication module, and a display panel (not illustrated). The host processor uses position data sequentially output from the sensor controller 18 to perform digital ink generation processing, pointer display processing, and the like.

The planar sensor 16 is, for example, a touch sensor of a capacitance system in which a plurality of sensor electrodes are arranged in a planar shape. The planar sensor 16 includes, for example, a plurality of X-line electrodes for detecting a position on an X-axis in a sensor coordinate system and a plurality of Y-line electrodes for detecting a position on a Y-axis. The line electrodes may be formed of a transparent conductive material including indium tin oxide (ITO) or wire mesh sensors. It should be noted that, instead of the above-described sensor of a mutual capacitance system, the planar sensor 16 may be a sensor of a self-capacitance system in which block-shaped electrodes are arranged in a two-dimensional lattice shape.

The sensor controller 18 is a control circuit that is connected to the planar sensor 16 and controls communication with the electronic pen 12 via the planar sensor 16. Specifically, the sensor controller 18 transmits an uplink signal US toward the electronic pen 12 and receives a downlink signal DS from the electronic pen 12 to detect an indicated position of the electronic pen 12.

### Configuration of Electronic Pen 12

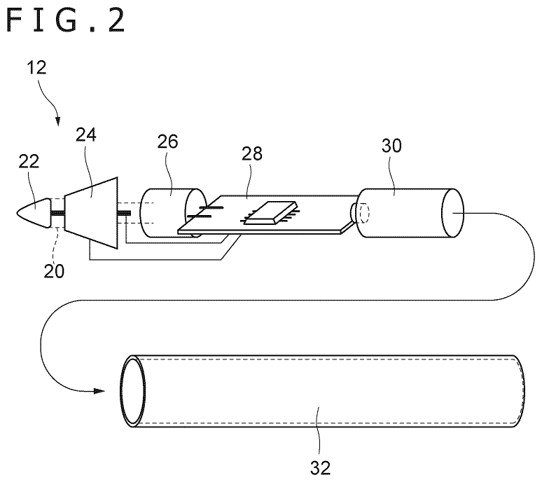

FIG. 2 is a diagram schematically depicting an internal structure of the electronic pen 12 of FIG. 1. The electronic pen 12 includes a core 20, a chip electrode 22, a ring electrode 24, a pen pressure sensor 26, a circuit substrate 28, a battery 30, and a housing 32.

The core 20 is a rod-shaped member arranged along a pen axis of the electronic pen 12. The chip electrode 22 and the ring electrode 24 are each made of or contain a conductive material such as metal. Specifically, the chip electrode 22 is a conical electrode attached to a tip end of the core 20. In addition, the ring electrode 24 is a tapered annular electrode whose diameter gradually decreases toward the tip end side.

The pen pressure sensor 26 is physically connected to the core 20, and is configured to be capable of detecting a pen pressure amount acting on the tip end side (i.e., a pen tip) of the core 20. As a detection system of the pen pressure sensor 26, for example, a capacitance system, a resistance film system, a piezoelectric element system, an optical system, or a micro electro-mechanical system (MEMS) may be used.

The circuit substrate 28 is a substrate configuring an electric circuit for controlling the electronic pen 12. The battery 30 is a power supply for supplying driving electric power to an electronic component or an electronic element provided on the circuit substrate 28. The housing 32 is configured to be capable of accommodating each of the above-described configuration components.

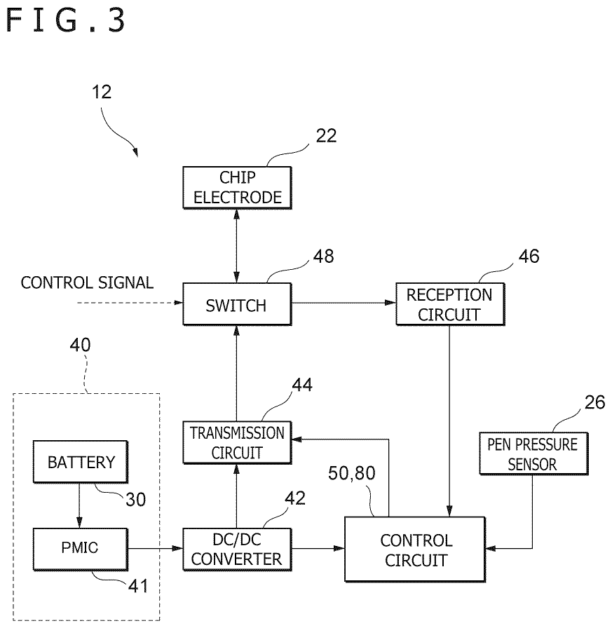

FIG. 3 is an electrical block diagram of the electronic pen 12 depicted in FIG. 1 and FIG. 2. The electronic pen 12 includes, in addition to the chip electrode 22 and the pen pressure sensor 26 (FIG. 2) described above, a power supply circuit 40, a direct current (DC)/DC converter 42, a transmission circuit 44, a reception circuit 46, a switch 48, and control circuits 50 and 80. It should be noted that, for convenience of explanation, the illustration of the configuration and electrical connection relation of the ring electrode 24 is omitted.

The power supply circuit 40 generates a driving voltage of the electronic pen 12 and outputs the obtained DC voltage toward the DC/DC converter 42. Specifically, the power supply circuit 40 includes the above-described battery 30 (FIG. 2) and a power management integrated circuit (IC) (hereinafter, a PMIC 41) responsible for electric power management of the battery 30.

The DC/DC converter 42 converts the DC voltage input from the power supply circuit 40 into a DC voltage suitable for each circuit, and then outputs the converted DC voltage to each of the transmission circuit 44 and the control circuit 50.

The transmission circuit 44 is a circuit that generates a downlink signal DS and then outputs the downlink signal DS toward the switch 48 and the chip electrode 22. Specifically, the transmission circuit 44 includes an oscillation circuit for generating a carrier signal oscillating at a predetermined frequency and a modulation circuit for modulating the carrier signal by using data included in a control signal from the control circuit 50.

The reception circuit 46 is a circuit that acquires an uplink signal US, via the chip electrode 22 and the switch 48, and then outputs the uplink signal US toward the control circuit 50. Specifically, the reception circuit 46 includes an analog circuit, which includes an amplifier circuit and an analog-to-digital (AD) conversion circuit, and a digital circuit, which includes a matched filter and a data restoring section.

The switch 48 is provided such that its input terminal is connected to the chip electrode 22, its first output terminal is connected to the transmission circuit 44, and its second output terminal is connected to the reception circuit 46. The switch 48 selectively connects the chip electrode 22 to the transmission circuit 44 or to the reception circuit 46.

The control circuits 50 and 80 are microcomputers responsible for control including a transmission operation of the downlink signal DS and a reception operation of the uplink signal US. The control circuits 50 and 80, through control of various parts, input the uplink signal US from the reception circuit 46, input a detected signal from the pen pressure sensor 26, output the downlink signal DS to the transmission circuit 44, and output the control signal to the switch 48.

### First Operation of Electronic Pen 12

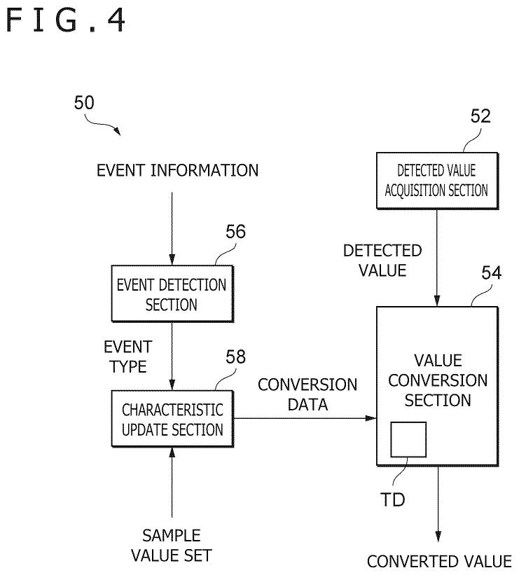

The electronic pen 12 in the present embodiment is configured as described above. Next, a first operation (more specifically, an operation related to a pen pressure adjustment) of the electronic pen 12 will be described with reference to FIG. 4 to FIG. 10.

### Functional Block Diagram of Control Circuit 50

FIG. 4 is a functional block diagram related to the first operation of the control circuit 50 depicted in FIG. 3. The control circuit 50 functions as a detected value acquisition section 52, a value conversion section 54, an event detection section 56, and a characteristic update section 58.

The detected value acquisition section 52 processes the detected signal output from the pen pressure sensor 26 (FIG. 2 and FIG. 3), and acquires a detected value correlated with the pen pressure amount. The number of quantized bits of the detected value is determined by the specifications of an AD converter (ADC). This detected value is supplied to each of the value conversion section 54, the event detection section 56, and the characteristic update section 58.

The value conversion section 54 converts the detected value acquired by the detected value acquisition section 52 into a converted value for indicating the magnitude of the pen pressure amount according to a conversion rule. The conversion rule is described by conversion data TD set in the value conversion section 54, and is more specifically expressed by a function (hereinafter, also referred to as a “conversion characteristic curve”) in a coordinate system including detected values on a first axis and converted values on a second axis. Here, a conversion characteristic curve 64 (FIG. 6) is a continuous function having one or more straight lines, one or more curves, or a combination thereof.

Every time the conversion data TD is updated through the characteristic update section 58, the value conversion section 54 performs conversion processing according to a new conversion rule described by the conversion data TD. The arithmetic operation processing for realizing the conversion processing includes a function operation, a lookup table (LUT) operation, a clipping operation, a bit shift operation, an offset adjustment, a gain adjustment, or a combination thereof.

It should be noted that the detected value and the converted value are each defined such that the pen pressure amount increases as the value increases. In particular, in a case where the converted value is defined such that the pen pressure amount linearly increases as the value increases, the correlation with the actual pen pressure amount becomes high, and thus, the electronic apparatus 14 can perform ink rendering which is closer to analog ink rendering.

The event detection section 56 analyzes information (hereinafter, event information) related to the occurrence of an event, detects a predetermined event, and supplies the type of the detected event to the characteristic update section 58. Examples of the event information include a reception result of the uplink signal US, identification information of an operation mode being executed, a power supply state, a detection history of the pen pressure amount, content of received data from the electronic apparatus 14, and the like. The types of events are classified into a “time event,” which indicates that there is sufficient time until when a pen pressure amount is detected, and an “abnormal change event,” which indicates an abnormality related to a detection result of a pen pressure amount.

For example, a time event may be that the electronic pen 12 has executed an operation, for which it is unlikely that a pen-down operation will be performed immediately after the time of execution of the operation. Examples of time events include: [1] that the electronic pen 12 has continuously failed to perform reception from the electronic apparatus 14 for a predetermined number of times or for a predetermined length of time (first event); [2] that the electronic pen 12 has shifted from an operation mode, in which power consumption is relatively large, to an operation mode, in which power consumption is relatively small (second event); and [3] that the electronic pen 12 has shifted from a power-off state to a power-on state (third event).

Examples of the “second event” include a shift from a normal mode to a power saving mode (or a sleep mode), and a shift from a power saving mode in which power consumption is relatively large to a power saving mode in which power consumption is relatively small. The “power saving mode” is an operation mode in which the frequency of execution of a specific driving operation related to at least one of a signal transmission/reception function or other functions is relatively low or the amount of execution of a specific driving operation is relatively small as compared with the case of the normal mode.

Examples of the “specific driving operation” in the transmission function include a boosting operation, a frequency hopping operation, a clock generation operation, and the like. Regarding a reception function, “the frequency of execution of a reception operation is low” means not only a case where the number of times of reception per unit time is low, but also a case where the number of times of reception is zero due to disabling of reception. Examples of “additional functions” include: [1] a communication function for performing communication in a system different from the AES system; [2] a pen pressure detection function for detecting a pen pressure amount; [3] an operation detection function for detecting an operation state of a switch of the electronic pen 12; [4] a vibration function for vibrating the electronic pen 12; and [5] a write function for writing data supplied from the electronic apparatus 14 into a memory.

An abnormal change event may be detected by the electronic pen 12 or by the electronic apparatus 14. In a case where an abnormal change event is detected by the electronic apparatus 14, the electronic apparatus 14 transmits to the electronic pen 12 a notification signal to give a notification of the occurrence of the abnormal change event or a request signal to request adjustment of the pen pressure amount. Examples of the abnormal change events include: [1] that the electronic apparatus 14 has not been able to acquire a pen pressure amount of the electronic pen 12 (hereinafter, a fourth event); and [2] that the pen pressure amount, within a predetermined period of time from the point in time when falling of a pen pressure is detected, has not been shifted from non-zero to zero (hereinafter, a fifth event).

The fifth event is detected by, for example, threshold value processing using two-step threshold values. The threshold value processing includes: [1] first determination processing for determining that the pen pressure amount has fallen below a first threshold value after the pen-down operation; and [2] second determination processing for determining that the pen pressure amount has fallen further below a second threshold value (near a zero value) after the first determination processing. In addition, the threshold value processing includes: [1] first determination processing for determining that the amount of time change (the amount of decrease) of the pen pressure amount has exceeded a first threshold value after the pen-down operation; and [2] second determination processing for determining that the pen pressure amount has fallen below a second threshold value (near a zero value) after the first determination processing. Accordingly, when the pen tip returns to the original state following a pen-up operation, any delay in restoration of the pen tip can be detected.

In response to detection of a predetermined event, the characteristic update section 58 updates the conversion characteristic curve 64 (FIG. 6) used for the conversion processing performed by the value conversion section 54. Specifically, the characteristic update section 58 generates the conversion data TD describing the conversion characteristic curve 64 according to the type of the event supplied from the event detection section 56, and supplies it to the value conversion section 54. The data format of the conversion data TD is determined according to the type of arithmetic operation at the time of the conversion processing.

The characteristic update section 58 adjusts the shape of the conversion characteristic curve 64 (FIG. 6) specified by the conversion rule, such as a rise sensitivity at which the pen pressure amount shifts from zero to non-zero. The characteristic update section 58 may adjust the rise sensitivity by moving the position of a point (hereinafter, an inflection point) at which the pen pressure amount shifts from zero to non-zero, along the first axis (i.e., the axis related to the detected values). In this case, the rise sensitivity increases by bringing the position of the inflection point closer to the origin, while the rise sensitivity decreases by bringing the position of the inflection point away from the origin. In addition, the characteristic update section 58 may adjust the rise sensitivity by changing an inclination at the inflection point. In this case, the rise sensitivity increases by increasing the inclination at the inflection point, while the rise sensitivity decreases by reducing the inclination at the inflection point.

The characteristic update section 58 may acquire a plurality of sample values from a set of detected values acquired by the detected value acquisition section 52 before or after the detection of an event, and may adjust the rise sensitivity on the basis of statistics related to the plurality of sample values. Any number of samples may be used as long as the number of pieces of data is statistically significant. Examples of the statistics include a mean value, a maximum value, a minimum value, the most frequent value, a median value, and the like.

The characteristic update section 58 may select either a detected value set obtained after the detection of an event or a detected value set obtained before the detection of an event, and acquire a plurality of sample values according to the type of the event. Specifically, the characteristic update section 58 may select the detected value “after the detection” in a situation where it is estimated that there is time to spare until a pen-down operation is performed, and may select the detected value “before the detection” in a situation where it is estimated that there is no time to spare until a pen-down operation is performed. The above-described first to third events are examples of events in which “there is time to spare.” The above-described fourth and fifth events are examples of events in which “there is no time to spare.”

In a case where the characteristic update section 58 selects the detected value set acquired after the detection of the event, the number of samples may be changed according to the type of event. Specifically, the characteristic update section 58 may increase the number of samples in a situation where it is estimated that there is time to spare until a pen-down operation is performed, and may decrease the number of samples in a situation where it is estimated that there is no time to spare until a pen-down operation is performed. The above-described first to third events are examples of events in which “there is time to spare.” The above-described fourth and fifth events are examples of events in which “there is no time to spare.” It should be noted that, in a case where the number of samples is included in a command signal from the electronic apparatus 14, the characteristic update section 58 may apply the number of samples designated by the electronic apparatus 14.

### Description of Conversion Characteristic Curve 64

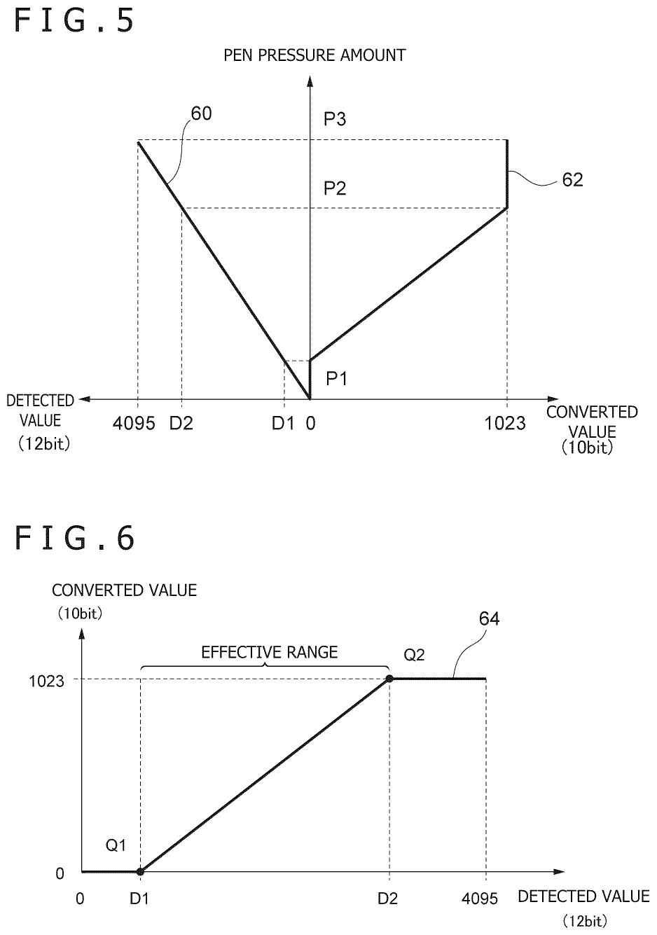

FIG. 5 is a diagram depicting an example of a correspondence relation between a detected value, a converted value, and a pen pressure amount. A first axis extending to the left of the graph indicates a 12-bit detected value (0 to 4095). A second axis extending upward in the graph indicates the pen pressure amount (the unit can freely be set, for example, gf). A third axis extending to the right of the graph indicates a 10-bit converted value (0 to 1023). It should be noted that the number of quantized bits of the detected value or the converted value is not limited to the example depicted in FIG. 5.

A first characteristic curve 60 is a curve related to the first axis (detected value) and the second axis (pen pressure amount). In the example of FIG. 5, the first characteristic curve 60 depicts a relation in which: [1] it passes through the origin (0, 0); and [2] the pen pressure amount increases roughly in a linear shape with respect to the detected value.

A second characteristic curve 62 is a curve related to the second axis (pen pressure amount) and the third axis (converted value). In the example depicted in the drawing, the second characteristic curve 62 depicts a relation in which: [1] the converted value is constant (minimum value=0) in a case where the pen pressure amount is equal to or smaller than P1; [2] the converted value linearly increases when the pen pressure amount exceeds P1; and [3] the converted value is constant (maximum value=1023) in a case where the pen pressure amount is equal to or larger than P2. Here, the pen pressure amount P1 corresponds to a detected value D1. In addition, the pen pressure amount P2 corresponds to each of a detected value D2 and the maximum value (1023) of the converted value. Further, the pen pressure amount P3 corresponds to each of the maximum value (4095) of the detected value and the maximum value (1023) of the converted value.

FIG. 6 is a diagram depicting the conversion characteristic curve 64 in the correspondence relation of FIG. 5. More specifically, the conversion characteristic curve 64 corresponds to a curve obtained by combining the first characteristic curve 60 and the second characteristic curve 62 of FIG. 5. The horizontal axis of the graph indicates a 12-bit detected value, and the vertical axis of the graph indicates a 10-bit converted value. The conversion characteristic curve 64 depicts a relation in which: [1] the converted value is the minimum value (0) in a case where the detected value is equal to or smaller than D1; [2] the converted value linearly increases when the detected value exceeds D1; and [3] the converted value is the maximum value (1023) in a case where the detected value is equal to or larger than D2.

Here, an inflection point Q1 (D1, 0) corresponds to the starting point of the rise in the conversion characteristic curve 64. In addition, an inflection point Q2 (D2, 0) corresponds to the starting point of saturation in the conversion characteristic curve 64. Hereinafter, a range having the inflection point Q1 as the lower limit and the inflection point Q2 as the upper limit is also referred to as an “effective range.”

### Update Operation of Conversion Characteristic Curve 64

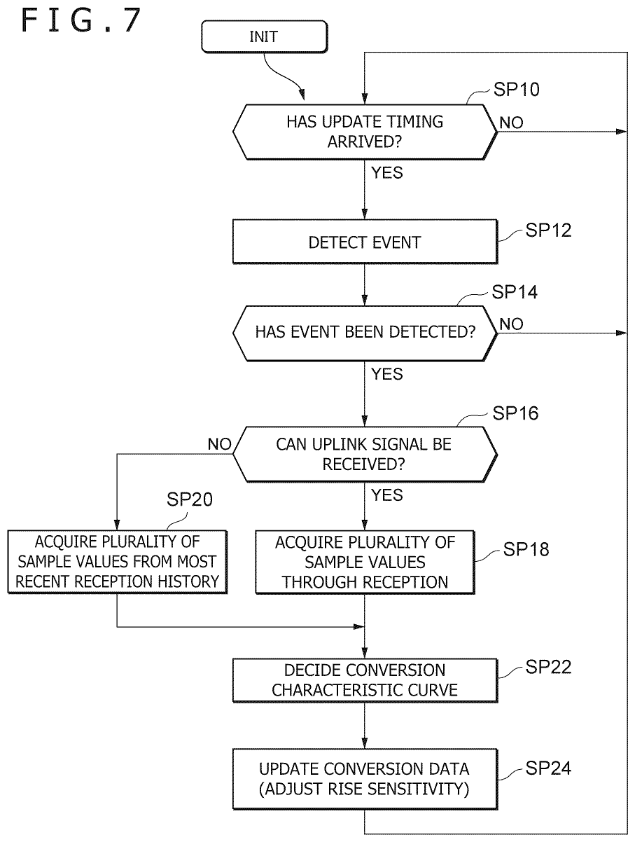

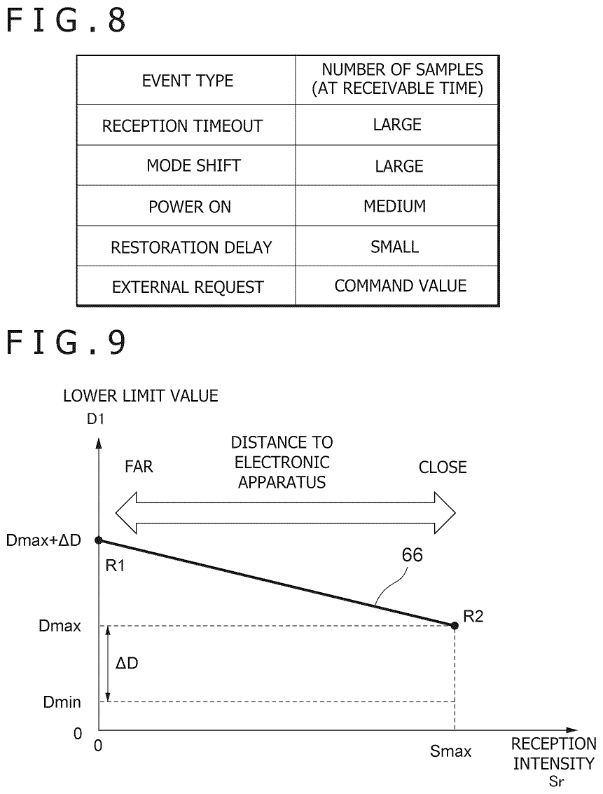

Next, an example of an update operation of the conversion characteristic curve 64 by the control circuit 50 depicted in FIG. 3 and FIG. 4 will be described with reference to a flowchart of FIG. 7 and FIG. 8. The flowchart of FIG. 7 is executed synchronously or asynchronously with the conversion processing by the value conversion section 54 (FIG. 4).

In Step SP10 of FIG. 7, the event detection section 56 confirms whether or not the timing (hereinafter, the update timing) for updating the conversion characteristic curve 64 has arrived. In a case where the update timing has not yet arrived (Step SP10: NO), the event detection section 56 remains in Step SP10 until the update timing arrives. On the other hand, in a case where the update timing has arrived (Step SP10: YES), the event detection section 56 proceeds to the next Step SP12.

In Step SP12, the event detection section 56 detects a predetermined event (for example, the first to fifth events described above) by using information (operation information) related to the operation of the electronic pen 12.

In Step SP14, the event detection section 56 confirms whether or not an event has been detected in Step SP12. In a case where no event has been detected (Step SP14: NO), the event detection section 56 returns to Step SP10 and then repeats Steps SP10 and SP12. On the other hand, in a case where an event has been detected (Step SP14: YES), the event detection section 56 supplies the type of the detected event to the characteristic update section 58, and then proceeds to the next Step SP16.

In Step SP16, the characteristic update section 58 confirms whether or not the electronic pen 12 is in a state where the uplink signal US can be received at the present time. The characteristic update section 58 proceeds to Step SP18 in a case where the reception is possible (Step SP16: YES), and proceeds to Step SP20 in a case where the reception is impossible (Step SP16: NO).

In Step SP18, the characteristic update section 58 acquires a plurality of sample values through the reception of the uplink signal US after the detection of the event, and proceeds to Step SP22.

FIG. 8 is a diagram for depicting an example of a method of setting the number of samples when reception is possible. More specifically, FIG. 8 depicts a correspondence relation between the type of event and the number of samples. In “signal timeout” (event 1) and “mode shift” (event 2), “large” is set. In “power on” (event 3), “medium” is set. In “restoration delay” (event 4), “small” is set. In “external request” (event 5), “command value” is set.

In Step SP20 of FIG. 7, the characteristic update section 58 acquires a plurality of sample values from the most recent reception history before the detection of an event, and proceeds to Step SP22.

In Step SP22, the characteristic update section 58 decides the conversion characteristic curve 64 at the current update timing by using the plurality of sample values acquired in Steps SP18 or SP20. Specifically, the characteristic update section 58 obtains statistics for the plurality of sample values, decides the current conversion characteristic curve 64 on the basis of the statistics, and generates the conversion data TD for specifying the conversion characteristic curve 64.

FIG. 9 is a diagram depicting an example of a method of determining the conversion characteristic curve 64. The graph in the drawing corresponds to a decision function 66 for determining the coordinates of the inflection point Q1 in FIG. 6, in other words, the lower limit value (detected value D1) of the effective range. The horizontal axis of the graph indicates a reception intensity Sr, and the vertical axis of the graph indicates the lower limit value (D1).

In the example of the drawing, the decision function 66 is a linear function connecting two points R1 and R2. The coordinates of R1 are (0, Dmax+Δ), and the coordinates of R2 are (Smax, Dmax). Δ=Dmax−Dmin is established. Dmax is the maximum value among N sample values obtained at the start of the current communication session. Dmin is the minimum value among N sample values obtained at the current update timing. Smax is the maximum value of the reception intensity Sr obtained in a case where the electronic pen 12 is in a contact state in the past reception history.

In Step SP24 of FIG. 7, the value conversion section 54 sets the conversion characteristic curve 64 decided in Step SP22. Specifically, the value conversion section 54 acquires the conversion data TD generated by the characteristic update section 58, and sets the conversion data TD in a usable state. Accordingly, the rise sensitivity of the conversion characteristic curve 64 is adjusted. Thereafter, the control circuit 50 returns to Step SP10, and then sequentially repeats Steps SP10 to SP24, so that a pen pressure sensitivity of the pen pressure sensor 26 is adjusted at suitable timings.

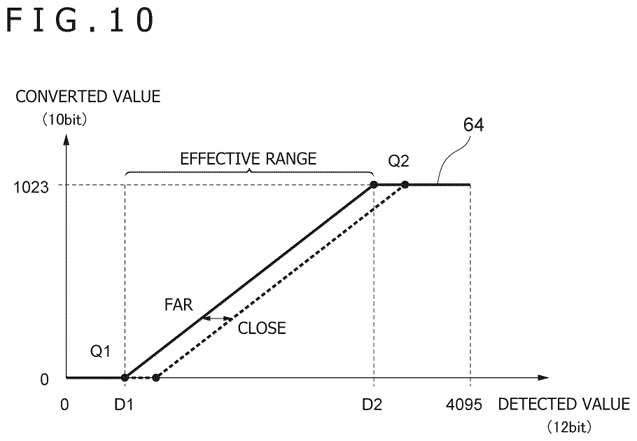

FIG. 10 is a diagram depicting an example of a method of adjusting the pen pressure sensitivity. The horizontal axis of the graph indicates a detected value, and the vertical axis of the graph indicates a converted value. The offset amount of the conversion characteristic curve 64 is adjusted according to the reception intensity (or, the height position) of the electronic pen 12, so that the effective range moves in parallel to the horizontal axis direction while the width of the effective range is kept constant.

For example, as the electronic pen 12 moves away from the electronic apparatus 14, the effective range of the conversion characteristic curve 64 moves in parallel to the right (a direction away from the origin), so that the rise sensitivity of the pen pressure amount is lowered. Accordingly, it is possible to suppress the occurrence of a phenomenon (so-called ink leakage) in which drawing is performed despite that the electronic pen 12 is in a hover state.

On the contrary, as the electronic pen 12 approaches the electronic apparatus 14, the effective range of the conversion characteristic curve 64 moves in parallel to the left (a direction approaching the origin), so that the rise sensitivity of the pen pressure amount increases. This enhances the responsiveness to the drawing operation by the electronic pen 12.

### Summary of First Operation

As described above, the input system 10 in the embodiment includes the electronic apparatus 14 having the planar sensor 16 and the electronic pen 12 for indicating a position on the planar sensor 16 through communication with the electronic apparatus 14. The electronic pen 12 includes the pen pressure sensor 26 for outputting a detected signal correlated with the pen pressure amount acting on the pen tip and the control circuit 50 connected to the pen pressure sensor 26. The control circuit 50 includes the value conversion section 54 for adjusting the rise sensitivity, in which the pen pressure amount shifts from zero to non-zero, in response to detection of a predetermined event, in the conversion characteristic curve 64 to which a detected value indicated by the detected signal output from the pen pressure sensor 26 is input and from which a converted value indicating the magnitude of the pen pressure amount is output.

According to the pen pressure output method in the embodiment, the control circuit 50 of the electronic pen 12 acquires the detected signal correlated with the pen pressure amount acting on the pen tip, and adjusts the rise sensitivity in which the pen pressure amount shifts from zero to non-zero, in response to detection of a predetermined event, in the conversion characteristic curve 64 to which a detected value indicated by the detected signal is input and from which a converted value indicating the magnitude of the pen pressure amount is output.

As described above, by adjusting the rise sensitivity in response to detection of a predetermined event, it is possible to suppress unwanted ink rendering in a manner that is not affected by the specifications of the electronic apparatus 14 for performing ink rendering.

Further, an event may be that the electronic pen 12 has executed an operation having a low possibility that a pen-down operation is immediately performed from the point in time of execution of the operation. For example, an event may be: [1] that the electronic pen 12 has continuously failed to perform reception from the electronic apparatus 14 for a predetermined number of times or for a predetermined length of time; [2] that the electronic pen 12 has shifted from an operation mode in which power consumption is relatively large to an operation mode in which power consumption is relatively small; and [3] that the electronic pen 12 has shifted from a power-off state to a power-on state. Accordingly, it is possible to adjust the rise sensitivity at the timing at which there is time to spare until a pen-down operation is expected to be performed.

Moreover, an event may be that the pen pressure amount has not shifted from non-zero to zero within a predetermined period of time from the point in time when falling of a pen pressure is detected. Accordingly, even in a case where the pen tip is not fully restored after a pen-up operation, desired pen pressure detection can be performed through the adjustment of the rise sensitivity.

In addition, an event may be that the electronic pen 12 has received from the electronic apparatus 14 a notification signal which gives a notification of the detection of an abnormal change related to the detection result of the pen pressure amount or a request signal which requests the adjustment of the rise sensitivity. Accordingly, the rise sensitivity can be adjusted in response to the notification or request from the electronic apparatus 14.

Further, the value conversion section 54 may acquire a plurality of sample values from a set of detected values, and may change the adjustment amount of the rise sensitivity on the basis of statistics related to the plurality of sample values. Accordingly, an adjustment is made in consideration of the statistical variation of the detected values.

Moreover, the value conversion section 54 may select either a detected value obtained before the detection of an event or a detected value obtained after the detection of an event and acquire a plurality of sample values according to the type of event. Accordingly, it is possible to select whether or not the sampling operation of the detected value is necessary after the detection of an event, according to the type of event.

Furthermore, in a case where a plurality of sample values acquired after the detection of an event are used, the value conversion section 54 may change the number of samples according to the type of event. Accordingly, the time required for sampling the detected value can be changed according to the type of event.

### Second Operation of Electronic Pen 12

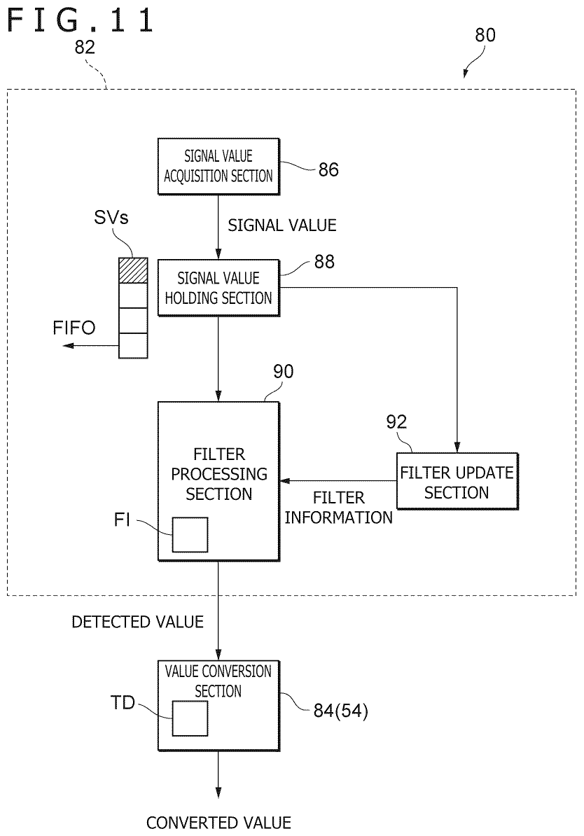

Next, a second operation (more specifically, an operation related to smoothing of a signal value) of the electronic pen 12 will be described with reference to FIG. 11 to FIG. 14.

### Functional Block Diagram of Control Circuit 80

FIG. 11 is a functional block diagram related to a second operation of the control circuit 80 depicted in FIG. 3. The control circuit 80 functions as a detected value calculation section 82 and a value conversion section 84.

The detected value calculation section 82 calculates a signal value (that is, a detected value) with a signal waveform or a frequency characteristic changed, by using a time series of signal values indicated by the detected signal from the pen pressure sensor 26 (FIG. 2 and FIG. 3). Specifically, the detected value calculation section 82 includes a signal value acquisition section 86, a signal value holding section 88, a filter processing section 90 (corresponding to a “signal processing section”), and a filter update section 92 (corresponding to a “processing update section”).

The signal value acquisition section 86 processes the detected signals sequentially output from the pen pressure sensor 26 in the same manner as that of the detected value acquisition section 52 depicted in FIG. 4, and acquires a signal value correlated with the pen pressure amount. The number of quantized bits of the signal value is determined by the specifications of the ADC. The signal values are sequentially supplied to the signal value holding section 88.

The signal value holding section 88 temporarily holds the time series of the signal values acquired by the signal value acquisition section 86, as a signal value set SVs. The signal value set SVs is held in, for example, a first-in first-out (FIFO) format. As the length of the buffer, any integer value equal to or larger than 2 is selected.

The filter processing section 90 applies signal processing to the signal value set SVs held by the signal value holding section 88, and acquires the signal value (that is, the detected value) with a signal waveform or a frequency characteristic changed in the signal value set SVs. “Changing a signal waveform” includes, for example, [1] making the signal value higher (or lower) on the whole while maintaining the overall shape of the signal waveform; [2] making the signal value forming a part of the original signal waveform relatively high (or low); [3] sharpening an edge portion of the signal waveform; [4] blunting an edge portion of the signal waveform, or the like. “Changing a frequency characteristic” includes using, for example, [1] a “smoothing filter” that lowers the frequency characteristic on the whole; [2] a “low-pass filter” that mainly passes a low-frequency band; [3] a “high-pass filter” that mainly passes a high-frequency band; [4] a “band-pass filter” that passes only a specific frequency band; or the like.

The signal processing described above is specified by information (hereinafter, “signal processing information”) related to presence or absence of said processing or to an arithmetic operation of said processing. For example, in a case where the signal processing is “filter processing,” the signal processing information includes filter information FI related to presence or absence of the filter processing or to an arithmetic operation of the filter processing.

In the present embodiment, the filter processing section 90 applies the filter processing to the signal value set SVs and acquires the signal value (that is, the detected value) with the frequency characteristic modulated. “Modulation of the frequency characteristic” includes, for example, “smoothing” in order to remove noise components contained in the detected signal. The frequency characteristic is specified by the filter information FI set in the filter processing section 90. The filter processing section 90 performs the filter processing according to the filter information FI every time the filter information FI is updated through the filter update section 92.

The filter information FI is information related to presence or absence of the filter processing or an arithmetic operation of the filter processing. The filter information FI includes, for example, a tap coefficient in a finite impulse response (FIR) filter. The number of taps of the FIR filter is an integer equal to or larger than 2, and may be a fixed value or a variable value.

In a case where the signal value at a time point t is Sp(t), the sampling interval is Δt, and the number of taps is 2, a detected value D (t) at time t is calculated according to the following Equation (1).

$$D ( t ) = γ \cdot Sp ( t ) + ( 1 - γ ) \cdot Sp ( t - Δ t ) \qquad ( 1 )$$

The tap coefficient γ is one aspect of the filter information FI and is a variable parameter that can be in the range of [0, 1]. As can be understood from the above Equation (1), γ=1 corresponds to “filter OFF” (or equivalence conversion). As the value of y decreases, the frequency characteristic becomes lower, or the filter smoothness becomes higher.

The filter update section 92, based on the magnitudes or the amounts of time changes of the signal values configuring the signal value set SVs, determines and updates the filter information FI related to presence or absence of the signal processing (here, the filter processing) or used for the filter processing. The “magnitudes of the signal values” are the magnitudes of one or more signal values configuring a value set {Sp(t−iΔt)} (i=0, 1, . . . , n−1). The “amounts of time changes of the signal values” are one or more amounts of time changes configuring a value set {ΔSp(i, j)} (i, j=0, 1, . . . , n−1). It should be noted that At is the sampling interval and that ΔSp(i, j)=|Sp(t−iΔt)−Sp(t−jΔt)| is satisfied.

The tap coefficient γ(t) at the time point t is obtained as, for example, the product of a smoothing coefficient α(t) and an activation multiplier β(t). Here, the smoothing coefficient α(t) corresponds to a coefficient that substantially determines the frequency characteristic of the filter and is a variable parameter that can be in the range of [0, 1]. In addition, the activation multiplier β(t) corresponds to a coefficient for specifying on/off of the filter processing and is a variable parameter that can take two values of 0 (off) or 1 (on).

$$γ ( t ) = 1 + ( α ( t ) - 1 ) β ( t ) \qquad ( 2 )$$

The smoothing coefficient α(t) is expressed by the following Equation (3) using any function F(⋅) in a general equation. For example, the smoothing coefficient α(t) is obtained as depicted in Equation (4) using any function F1(⋅), and as depicted in Equation (5) using any function F2(⋅).

$$α ( t ) = F ( \{ Sp ( t - i Δ t ) \} , \{ Δ Sp ( i , j ) \} ) \qquad ( 3 )$$

$$α ( t ) = F 1 ( Sp ( t ) ) \qquad ( 4 )$$

$$α ( t ) = F 2 ( Δ Sp ( 0 , 1 ) ) \qquad ( 5 )$$

The filter update section 92 determines the filter information FI such that the frequency characteristic becomes higher as the signal value becomes smaller or that the frequency characteristic becomes lower as the signal value becomes larger. In the example of Equation (4), the function F1(x) is a function (a monotone nonincreasing function) that includes a zone that monotonically decreases or is constant as x increases.

The filter update section 92 may determine the filter information FI such that the frequency characteristic becomes lower as the amount of time change becomes smaller or that the frequency characteristic becomes higher as the amount of time change becomes larger. In the example of Equation (5), the function F2(x) is a function (a monotone nondecreasing function) that includes a zone that monotonically increases or is constant as x increases.

The activation multiplier β(t) is expressed by the following Equation (6) using any function G(⋅) in a general equation. For example, the activation multiplier β(t) is obtained as depicted in Equation (7) using any function G1(⋅).

$$β ( t ) = G ( \{ Sp ( t - i Δ t ) \} , \{ Δ Sp ( i , j ) \} ) \qquad ( 6 )$$

$$β ( t ) = G 1 ( Sp ( t ) ) \qquad ( 7 )$$

Of the entire zone in which the signal value can be obtained, in a partial zone including the detected value D1 (that is, an inflection point detected value) corresponding to the inflection point Q1 (FIG. 6) on the conversion characteristic curve 64, the filter update section 92 does not execute the signal processing (the filter processing), but executes the signal processing (the filter processing) outside the partial zone. In the example of a combination of Equation (2) and Equation (7), β(t)=0 is satisfied in a case where Sp(t) belongs to the partial zone, and β(t)=1 is satisfied in a case where Sp(t) does not belong to the partial zone.

The value conversion section 84 converts the detected value calculated by the detected value calculation section 82 into a converted value indicating the magnitude of the pen pressure amount according to a conversion rule. The conversion rule is described by the conversion data TD set in the value conversion section 84. It should be noted that the value conversion section 84 may be replaced with the value conversion section 54 depicted in FIG. 4.

### Smoothing Operation of Signal Value

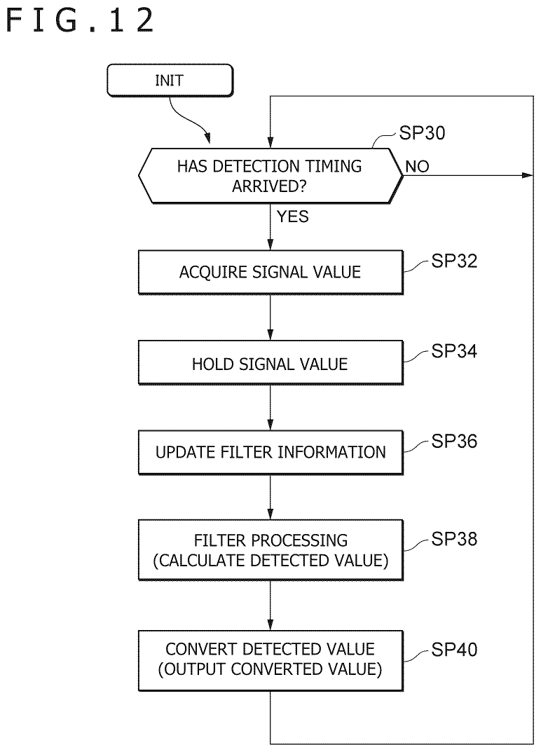

Next, an example of a smoothing operation of the signal value performed by the control circuit 80 of FIG. 3 and FIG. 11 will be described with reference to a flowchart of FIG. 12 and FIG. 13 and FIG. 14. The flowchart of FIG. 12 is executed synchronously or asynchronously with the update processing of the conversion characteristic curve 64 (FIG. 6).

In Step SP30 of FIG. 12, the signal value acquisition section 86 confirms whether or not the timing (hereinafter, the detection timing) for detecting the pen pressure amount of the electronic pen 12 has arrived. In a case where the detection timing has not yet arrived (Step SP30: NO), the signal value acquisition section 86 remains in Step SP30 until the detection timing arrives. On the other hand, in a case where the detection timing has arrived (Step SP30: YES), the signal value acquisition section 86 proceeds to the next Step SP32.

In Step SP32, the signal value acquisition section 86 performs sampling processing on the detected signal output from the pen pressure sensor 26, and acquires a signal value Sp(t) at the present time t.

In Step SP34, the signal value holding section 88 temporarily holds the signal value Sp(t) acquired in Step SP32. Accordingly, the signal value set SVs representing a value set {Sp(t−iΔt)} is updated.

In Step SP36, the filter update section 92 determines the filter information FI by using the signal value set SVs held in Step SP34. Here, the filter update section 92 calculates the smoothing coefficient α(t) according to Equation (5), the activation multiplier β(t) according to Equation (7), and the tap coefficient γ(t) according to Equation (2). Accordingly, the filter information FI is determined and supplied to the filter processing section 90.

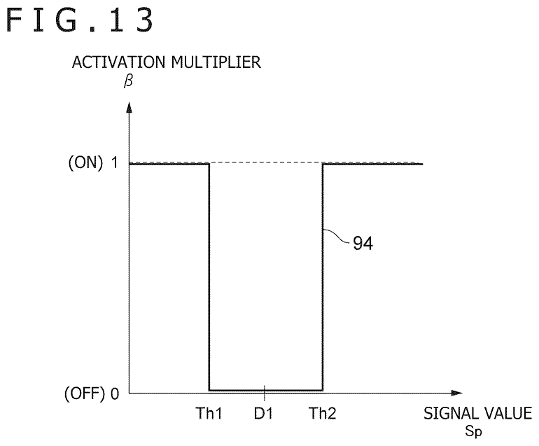

FIG. 13 is a diagram depicting an example of a method of determining the activation multiplier β. The horizontal axis of the graph indicates a signal value Sp, and the vertical axis of the graph indicates the activation multiplier β. An activation multiplier β(Sp) is specified by two threshold values Th1 and Th2. The threshold values Th1 and Th2 satisfy a magnitude relation of 0<Th1<D1<Th2. Here, D1 is a detected value corresponding to the inflection point Q1 (FIG. 6) on the conversion characteristic curve 64. The activation multiplier β(Sp) takes a value of “1” in the range of 0≤Sp<Th1 [1], takes a value of “0” in the range of Th1≤Sp≤Th2 [2], and takes a value of “1” in the range of Sp>Th2 [3]. In the example of FIG. 13, the width of the filter dead zone corresponds to (Th2−Th1).

In Step SP38 of FIG. 12, the filter processing section 90 performs the filter processing on the signal value set SVs held in Step SP34, by using the filter information FI updated in Step SP36. Accordingly, the signal value (that is, the detected value) with the frequency characteristic modulated is obtained.

In Step SP40, the value conversion section converts the detected value obtained through the filter processing in Step SP38 into a converted value indicating the magnitude of the pen pressure amount. Thereafter, the control circuit 80 returns to Step SP30, and then sequentially repeats Steps SP30 to SP40 to regularly or irregularly output the pen pressure amount.

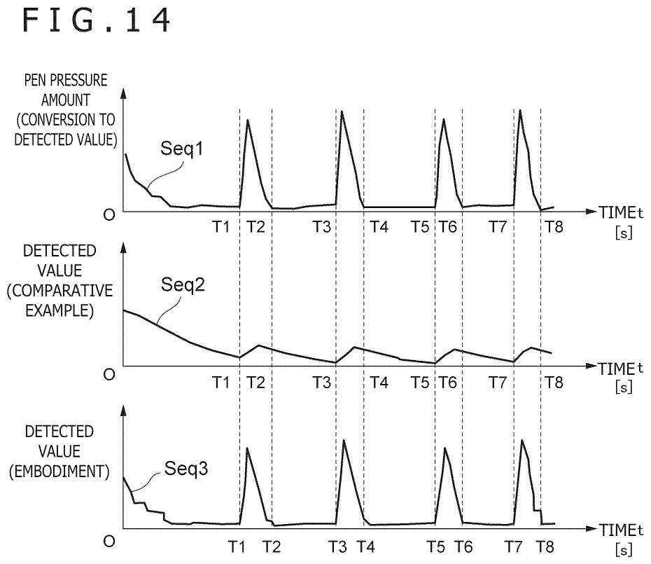

FIG. 14 is a diagram depicting effects of adaptive filter processing. The horizontal axis of the graph indicates time, and the vertical axis of the graph indicates a detected value. All of time series Seq1 to Seq3 depict the behaviors of the detected values obtained in a case where a touch operation by the electronic pen 12 is repeated. Specifically, the pen tip of the electronic pen 12 is in a “contact state” in four time zones t=T1 to T2, t=T3 to T4, t=T5 to T6, and t=T7 to T8.

The time series Seq1 corresponds to an “ideal behavior” and is a set of ideal values obtained by converting the actual measurement result of the pen pressure amount into a detected value. The time series Seq2 corresponds to a “comparative example” and is a set of detected values obtained by applying the same filter processing regardless of a change in the detected value. The time series Seq3 corresponds to a present “embodiment” and is a set of detected values obtained by the detected value calculation section 82 of FIG. 11 applying adaptive filter processing.

As can be understood from the comparison between the time series Seq1 and Seq2, in the time series Seq2, as the rise sensitivity and a falling sensitivity become lower, the peak of the detected value becomes smaller. That is, in the filter processing of the “comparative example,” a situation where the pen pressure amount cannot be accurately detected may occur due to excessive smoothing. On the other hand, as can be understood from the comparison between the time series Seq1 and Seq3, the time series Seq3 depicts almost the same behavior as that of the time series Seq1. That is, in the filter processing of the “embodiment,” the pen pressure amount can be more accurately detected through the selection of a filter according to the magnitude or the amount of time change of the signal value.

### Summary of Second Operation

As described above, the input system 10 of the present embodiment includes the electronic apparatus 14 having the planar sensor 16 and the electronic pen 12 for indicating a position on the planar sensor 16 through communication with the electronic apparatus 14. The electronic pen 12 includes the pen pressure sensor 26 for outputting a detected signal correlated with the pen pressure amount acting on the pen tip and the control circuit 80 connected to the pen pressure sensor 26. The control circuit 80 includes the signal processing section (here, the filter processing section 90) that applies signal processing to the time series (here, the signal value set SVs) of the signal values indicated by the detected signals and acquires a detected value that is a signal value with the signal waveform or the frequency characteristic changed in the signal value set SVs. The control circuit 80 includes the processing update section (here, the filter update section 92) that sequentially updates the signal processing information (here, the filter information FI) related to presence or absence of the signal processing or an arithmetic operation of the signal processing according to the magnitude or the amount of time change of the signal value.

According to the pen pressure output method of the present embodiment, the control circuit 80 of the electronic pen 12 acquires the detected signal correlated with the pen pressure amount acting on the pen tip, applies the signal processing to the time series (here, the signal value set SVs) of the signal values indicated by the detected signals, acquires a detected value that is a signal value with the signal waveform or the frequency characteristic changed in the signal value set SVs, and sequentially updates the signal processing information (here, the filter information FI) related to presence or absence of or an arithmetic operation of the signal processing according to the magnitude or the amount of time change of the signal value.

With such a configuration, it is possible to execute signal processing according to the magnitude or the amount of time change of the signal value, and it is possible to suppress unwanted ink rendering in a manner that is not affected by the specifications of the electronic apparatus 14 for performing ink rendering.

In addition, in a case where the signal processing includes filter processing to modulate the frequency characteristic of the signal value set SVs, the signal processing information may include the filter information FI related to presence or absence of the filter processing or an arithmetic operation of the filter processing.

Further, the filter update section 92 may determine and update the filter information FI such that the frequency characteristic becomes lower as the amount of time change becomes smaller or that the frequency characteristic becomes higher as the amount of time change becomes larger. Accordingly, it is possible to suppress smoothing for a zone with a large amount of time change in the signal value set SVs.

Moreover, the filter update section 92 may determine and update the filter information FI such that the frequency characteristic becomes higher as the signal value becomes smaller. Accordingly, it is possible to suppress smoothing for a zone, within the signal value set SVs, having small signal values (for example, the rising zone of the pen pressure amount).

Furthermore, of the entire zone in which the signal value can be obtained, within a partial zone including the inflection point detected value (D1) that is the detected value corresponding to the inflection point, the filter update section 92 may not execute the signal processing, but may execute the signal processing outside the partial zone. Accordingly, it is possible to suppress a change in the signal waveform or the frequency characteristic for the rising zone of the pen pressure amount in the signal value set SVs.

### Modification Examples

It is obvious that the present disclosure is not limited to the above-described embodiment and can freely be changed without departing from the principles disclosed herein. Alternatively, the configurations may freely be combined as long as the combination does not cause technical inconsistency. Alternatively, presence or absence of execution, or the execution order of the steps constituting the flowchart, may be changed as long as the change does not cause technical inconsistency.

Although a case where the electronic pen 12 is an AES stylus has been described as an example in the above-described embodiment, the electronic pen 12 may alternatively be an electro-magnetic resonance (EMR) stylus. In such device configuration, the electronic apparatus 14 is provided with a planar sensor in which a plurality of loop coils are formed, and the electronic pen 12 is provided with a reception circuit for receiving a magnetic field signal emitted by the planar sensor.

Although a case where the electronic pen 12 receives a signal through communication using capacitance coupling with the planar sensor 16 of the electronic apparatus 14 and adjusts the rise sensitivity according to the intensity of the received signal has been described as an example in the above-described embodiment, the communication method is not limited this example. For example, the intensity of a received signal obtained through another wireless communication section such as Bluetooth®, Bluetooth® Low Energy (BLE), or ultra-wide band (UWB) may be used.

Although a case where the control circuit 80 applies the signal processing to a digital signal after sampling has been described as an example in the above-described embodiment, the arithmetic operation method is not limited to the digital signal processing. For example, the control circuit 80 may perform various types of signal processing (specifically, smoothing processing via an analog filter or the like) on an analog signal before sampling.

1. An electronic pen that indicates a position on a planar sensor through communication with an electronic apparatus having the planar sensor, the electronic pen comprising:
a pen pressure sensor that outputs a detected signal correlated with a pen pressure amount acting on a pen tip; and
a control circuit that is connected to the pen pressure sensor and adjusts, on a conversion characteristic curve to which a detected value indicated by the detected signal output from the pen pressure sensor is input and from which a converted value indicating a magnitude of the pen pressure amount is output, a rise sensitivity in which the pen pressure amount shifts from zero to non-zero, in response to detection of a predetermined event.

2. The electronic pen according to claim 1, wherein the event is:
that the electronic pen has continuously failed to perform reception from the electronic apparatus for a predetermined number of times or for a predetermined length of time,
that the electronic pen has shifted from an operation mode in which power consumption is relatively large to an operation mode in which power consumption is relatively small, or
that the electronic pen has shifted from a power-off state to a power-on state.

3. The electronic pen according to claim 1, wherein the event is that the electronic pen has executed an operation having a low possibility that a pen-down operation is immediately performed from a point in time of execution of the operation.

4. The electronic pen according to claim 1, wherein the event is that the pen pressure amount has not shifted from non-zero to zero within a predetermined period of time from a point in time of detection of falling of the pen pressure amount.

5. The electronic pen according to claim 1, wherein the event is that the electronic pen has received from the electronic apparatus a notification signal for giving a notification of detection of an abnormality related to a detection result of the pen pressure amount or a request signal for requesting an adjustment of the rise sensitivity.

6. The electronic pen according to claim 1, wherein the control circuit acquires a plurality of sample values from a set of the detected values, and changes an adjustment amount of the rise sensitivity on a basis of statistics related to the plurality of sample values.

7. The electronic pen according to claim 1, wherein the control circuit selects either the detected value obtained before the detection of the event or the detected value obtained after the detection of the event, and acquires a plurality of sample values according to a type of the event.

8. The electronic pen according to claim 1, wherein, in a case where a plurality of sample values acquired after the detection of the event are used, the control circuit changes the number of samples according to a type of the event.

9. A pen pressure output method for an electronic pen that indicates a position on a planar sensor through communication with an electronic apparatus having the planar sensor, the pen pressure output method comprising:
by the electronic pen,
acquiring a detected signal correlated with a pen pressure amount acting on a pen tip; and
adjusting, on a conversion characteristic curve to which a detected value indicated by the acquired detected signal is input and from which a converted value indicating a magnitude of the pen pressure amount is output, a rise sensitivity in which the pen pressure amount shifts from zero to non-zero, in response to detection of a predetermined event.

10. An electronic pen that indicates a position on a planar sensor through communication with an electronic apparatus having the planar sensor, the electronic pen comprising:
a pen pressure sensor that sequentially outputs a detected signal correlated with a pen pressure amount acting on a pen tip; and
a control circuit that is connected to the pen pressure sensor,
wherein the control circuit includes:
a signal processing section that applies signal processing to a time series of signal values indicated by the detected signals and acquires a detected value, which is the signal value with a signal waveform or a frequency characteristic changed in the time series of signal values, and
a processing update section that sequentially updates signal processing information related to presence or absence of the signal processing or an arithmetic operation of the signal processing according to a magnitude or an amount of time change of the signal value.

11. The electronic pen according to claim 10, wherein the signal processing includes filter processing for modulating the frequency characteristic in the time series of the signal values, and
the signal processing information includes filter information related to presence or absence of the filter processing or an arithmetic operation of the filter processing.

12. The electronic pen according to claim 11, wherein the processing update section determines and updates the filter information such that the frequency characteristic becomes lower as the amount of time change becomes smaller or that the frequency characteristic becomes higher as the amount of time change becomes larger.

13. The electronic pen according to claim 11, wherein the processing update section determines and updates the filter information such that the frequency characteristic becomes higher as the signal value becomes smaller.

14. The electronic pen according to claim 10, wherein, when a point where the pen pressure amount shifts from zero to non-zero is defined as an inflection point on a conversion characteristic curve to which the detected value is input and from which a converted value indicating a magnitude of the pen pressure amount is output, the processing update section determines the signal processing information such that, of an entire zone in which the signal value is allowed to be obtained, the signal processing is not executed within a partial zone including an inflection-point-detection value that is the detected value corresponding to the inflection point but the signal processing is executed outside the partial zone.

15. A pen pressure output method for an electronic pen that indicates a position on a planar sensor through communication with an electronic apparatus having the planar sensor, the pen pressure output method comprising:
by the electronic pen,
sequentially acquiring a detected signal correlated with a pen pressure amount acting on a pen tip;
applying signal processing to a time series of signal values indicated by the detected signals and acquiring a detected value that is the signal value with a signal waveform or a frequency characteristic changed in the time series of the signal values; and
sequentially updating signal processing information related to presence or absence of the signal processing or an arithmetic operation of the signal processing according to a magnitude or an amount of time change of the signal value.
